(19) United States
(12) Patent Application Publication
(10) Pub. No.: US 2026/0267181 A1
(43) Pub. Date: Sep. 10, 2026

(54) DISPLAY DEVICE

(71) Applicant: E Ink Holdings Inc., HSINCHU (TW)

(72) Inventors: Sheng-Wei CHEN, HSINCHU (TW); Chi-Mao HUNG, HSINCHU (TW)

(21) Appl. No.: 19/419,143

(22) Filed: Dec. 15, 2025

(30) Foreign Application Priority Data
Mar. 6, 2025 (TW) 114108406

(51) Int. Cl. G02F 1/133; G02F 1/167; G02F 1/16755; G02F 1/16766; G02F 1/1677; G02F 1/1685

(52) U.S. Cl. CPC G02F 1/13324; G02F 1/167; G02F 1/16755; G02F 1/16766; G02F 1/1677; G02F 1/1685

(57) ABSTRACT

A display device includes a first substrate, multiple first pixel electrodes, multiple second pixel electrodes, a display medium, a second substrate and multiple solar cells. The first pixel electrodes and the second pixel electrodes are disposed on the first substrate. The display medium is disposed on the first pixel electrodes and the second pixel electrodes. The second substrate is disposed opposite to the first substrate. The solar cells are disposed between the first substrate and the second substrate, and overlap the first pixel electrodes in the normal line of the first substrate, respectively.

### CROSS-REFERENCE TO RELATED APPLICATION

This application claims priority to Taiwan Application Serial Number 114108406, filed Mar. 6, 2025, which is herein incorporated by reference in its entirety.

### BACKGROUND

### Field of Invention

The present disclosure relates to a display device. More particularly, the present disclosure relates to a display device including solar cells.

### Description of Related Art

With the development of the technology industry, display devices have been widely used in daily life, such as in advertising billboard, electronic paper. For example, a display device using certain types of display medium has the advantage of very low energy consumption. When the displayed image does not change, no power is consumed, and when the displayed image changes, only a very limited amount of power is consumed. Therefore, if combined with a solar cell to supply power, the aforementioned display device may not require an external power supply. However, when a display device is combined with a solar cell, the display area and the solar cell are usually located in separate areas. In order to avoid occupying the area of the display area, the area where the solar cell is set cannot be too large, resulting in the solar cell being unable to generate enough electricity to supply the display device. If a larger area is designed for the solar cell, the area of the display area will be reduced or the appearance of the display device will be poor.

### SUMMARY

At least one embodiment of the present disclosure provides a display device including a solar cell correspond to a pixel electrode, which can generate sufficient power to supply the display device and improve the appearance of the display device without reducing the area of the display area.

The display device according to at least one embodiment of the present disclosure includes a first substrate, multiple first pixel electrodes, multiple second pixel electrodes, a display medium, a second substrate, and multiple solar cells. The first pixel electrodes are disposed on the first substrate. The second pixel electrodes are disposed on the first substrate. The display medium is disposed on the first pixel electrodes and the second pixel electrodes. The second substrate is disposed opposite to the first substrate. The solar cells are disposed between the first substrate and the second substrate, and overlap the first pixel electrodes in the normal line of the first substrate, respectively.

The display device according to at least another embodiment of the present disclosure includes a first substrate, multiple first pixel electrodes, multiple second pixel electrodes, a display medium, a second substrate, and multiple solar cells. The first pixel electrodes are disposed on the first substrate. The second pixel electrodes are disposed on the first substrate. The display medium is disposed on the first pixel electrodes and the second pixel electrodes. The second substrate is disposed opposite to the first substrate, and has a display surface facing away from the first substrate and an inner surface facing the first substrate. The solar cells are disposed between the first substrate and the inner surface of the second substrate, and overlap the first pixel electrodes in the normal line of the first substrate, respectively.

It is to be understood that both the foregoing general description and the following detailed description are by examples, and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic top view of a display device according to at least one embodiment of the present disclosure.

FIG. 2 is a partial schematic cross-sectional view of a display area of a display device according to at least one embodiment of the present disclosure.

FIG. 3 is a partial schematic cross-sectional view of a display area of a display device according to at least another embodiment of the present disclosure.

FIG. 4 is a partial schematic cross-sectional view of a display area of a display device according to at least another embodiment of the present disclosure.

FIG. 5 is a partial schematic cross-sectional view of a display area of a display device according to at least another embodiment of the present disclosure.

FIG. 6 is a partial schematic cross-sectional view of a display area of a display device according to at least another embodiment of the present disclosure.

FIG. 7 is a partial schematic cross-sectional view of a display area of a display device according to at least another embodiment of the present disclosure.

FIG. 8 is a partial schematic cross-sectional view of a display area of a display device according to at least another embodiment of the present disclosure.

### DETAILED DESCRIPTION

The embodiments of the present disclosure are discussed in detail below. It will be appreciated, however, that the embodiments provide many applicable concepts which may be implemented in a wide variety of specific contexts. The discussed and disclosed embodiments are for illustrative purposes only and are not intended to limit the scope of patent applications in this case.

In the following description, in order to clearly present the technical features of the present disclosure, the dimensions of elements in the drawings will be enlarged in unequal proportions. Therefore, the description and explanation of the following embodiments are not limited to the sizes and shapes presented by the elements in the drawings, but should cover the sizes, shapes, and deviations of the two due to actual manufacturing processes and/or tolerances. For example, the flat surface shown in the drawings may have rough and/or non-linear characteristics, and the acute angle shown in the drawings may be round. Therefore, the elements presented in the drawings in this case are mainly for illustration, and are not intended to accurately depict the actual shape of the elements, nor are they intended to limit the scope of patent applications in this case.

The spatial relative terms used in the present disclosure, such as “below,” “under,” “above,” “on,” and the like, are intended to facilitate the recitation of a relative relationship between one element or feature and another as depicted in the drawings. The true meaning of these spatial relative terms includes other orientations. For example, the relationship between one element and another may change from “below” and “under” to “above” and “on” when the drawing is turned 180 degrees up or down. In addition, spatially relative descriptions used in the present disclosure should be interpreted in the same manner.

It should be understood that while the present disclosure may use terms such as “first”, “second”, “third” to describe various elements or features, these elements or features should not be limited by these terms. These terms are primarily used to distinguish one element from another or one feature from another. In addition, the term “or” as used in the present disclosure may include, as appropriate, any one or a combination of the listed items in association.

Moreover, the present disclosure may be implemented or applied in various other specific embodiments, and the details of the present disclosure may be combined, modified, and altered in various embodiments based on different viewpoints and applications, without departing from the idea of the present disclosure.

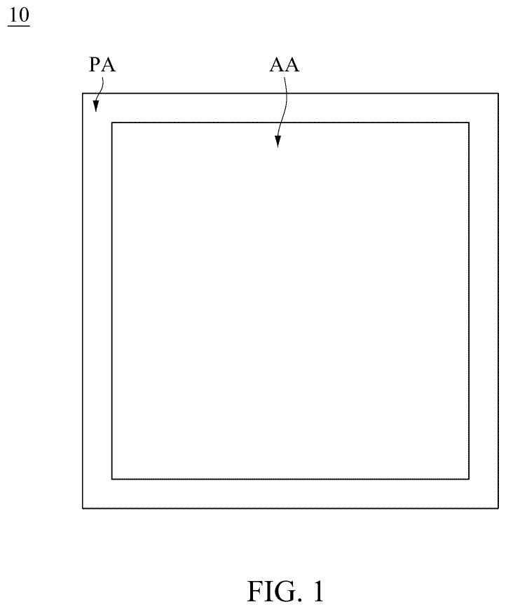

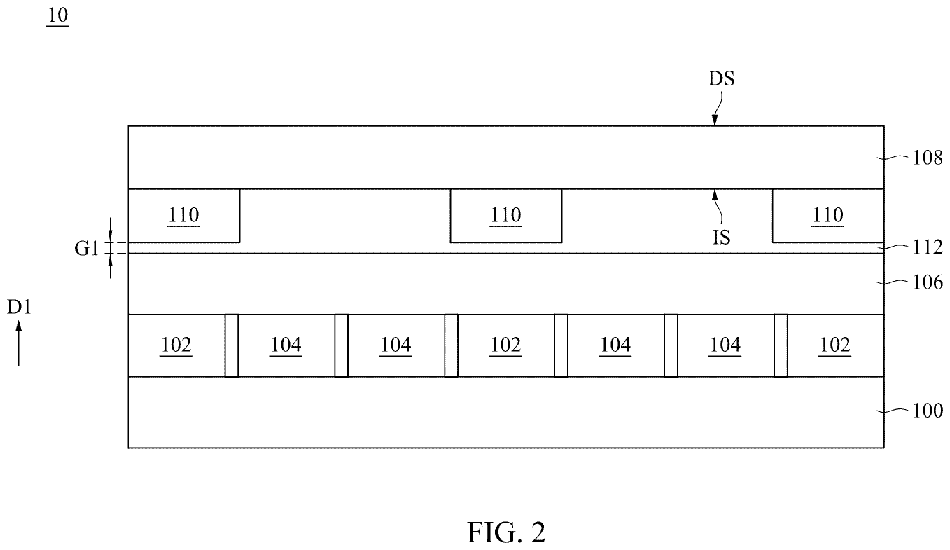

FIG. 1 is a schematic top view of a display device 10 according to at least one embodiment of the present disclosure. FIG. 2 is a partial schematic cross-sectional view of a display area AA of a display device 10 according to at least one embodiment of the present disclosure. Referring to FIG. 1 and FIG. 2, the display device 10 has a display area AA and a peripheral area PA adjacent to the display area AA, and the display device 10 includes a first substrate 100, multiple first pixel electrodes 102, multiple second pixel electrodes 104, a display medium 106, a second substrate 108, and multiple solar cells 110.

The first pixel electrodes 102 are disposed on the first substrate 100. The second pixel electrodes 104 are disposed on the first substrate 100. The display medium 106 is disposed on the first pixel electrodes 102 and the second pixel electrodes 104. The second substrate 108 is disposed opposite to the first substrate 100. The solar cells 110 are disposed between the first substrate 100 and the second substrate 108, and overlap the first pixel electrodes 102 in the normal line of the first substrate 100 (i.e., a first direction D1), respectively.

Since the solar cells 110 are disposed in the display area AA in correspondence with the first pixel electrodes 102, and the second pixel electrodes 104 are used for displaying image, sufficient power can be generated to supply the display device 10 without reducing the area of the display area AA and the appearance of the display device 10 can be improved.

In some embodiments, the solar cells 110 at least partially overlap or completely overlap the first pixel electrodes 102, respectively. The total area of the first pixel electrodes 102 is smaller than the total area of the second pixel electrodes 104. That is, the total area of the solar cells 110 overlapping the first pixel electrodes 102 is smaller than the total area of the second pixel electrodes 104. For example, the ratio of the total area of the first pixel electrodes 102 to the sum of the total area of the first pixel electrodes 102 and the total area of the second pixel electrodes 104 is 0.05 to 0.5, that is, the ratio of the total area of the solar cell 110 to the sum of the total area of the first pixel electrodes 102 and the total area of the second pixel electrodes 104 is 0.05 to 0.5. With the aforementioned design, the solar cells 110 within this total area ratio range can generate enough power to supply the display device 10, and the second pixel electrodes 104 within this total area ratio range and not overlapping the solar cells 110 are sufficient to display image.

It should be noted that, in order to simplify the expression of the figure, FIG. 2 merely depicts three first pixel electrodes 102, four second pixel electrodes 104, and three solar cells 110 as a representative illustration. However, it should be understood that other first pixel electrodes 102, second pixel electrodes 104 and solar cells 110 may be included where not shown in the figure.

In some embodiments, the first pixel electrodes 102 may drive the display medium 106 corresponding to the first pixel electrodes 102 to display an image. The color of the image is not black, that is, an image with a light absorptivity less than 100%, for example, a white image. With the aforementioned design, the first pixel electrodes 102 corresponding to the solar cells 110 and the image displayed by the display medium 106 corresponding to the first pixel electrodes 102 can avoid absorbing light and affecting the efficiency of the solar cells 110. The aforementioned displayed image can even help reflect light and thus improve the efficiency of the solar cells 110.

Referring to FIG. 2, the display device 10 further includes a connection layer 112, the connection layer 112 is disposed between the display medium 106 and the second substrate 108 and connects to the display medium 106 and the second substrate 108, and the solar cells 110 are disposed between the second substrate 108 and the connection layer 112.

In detail, the second substrate 108 has a display surface DS facing away from the first substrate 100 and an inner surface IS facing the first substrate 100. The solar cells 110 may be formed on the inner surface IS of the second substrate 108, for example, in contact with the inner surface IS of the second substrate 108. The display medium 106 may be formed on the first pixel electrodes 102 and the second pixel electrodes 104, for example, in contact with the first pixel electrodes 102 and the second pixel electrodes 104. The connection layer 112 is disposed between the solar cells 110, the second substrate 108 and the display medium 106 for connecting to the solar cells 110, the second substrate 108 and the display medium 106. That is, a gap G1 may exist between the solar cells 110 and the display medium 106, and the connection layer 112 may be located in the gap G1.

In some embodiments, the first substrate 100 and the second substrate 108 are, for example, glass substrates, plastic substrates, silicon substrates, flexible substrates or other suitable substrates, or the first substrate 100 may be an array substrate, for example, may include switching elements (not shown, such as transistors) or other electronic elements (not shown, such as capacitors).

The material of the first pixel electrodes 102 and the material of the second pixel electrodes 104 may include an opaque conductive material, a transparent conductive material or a combination thereof. The opaque conductive material may be a metal, such as molybdenum, or a metal compound, such as molybdenum nitride, molybdenum niobium. The transparent conductive material may be, for example, indium tin oxide, indium zinc oxide.

The display medium 106 may be an electrophoretic display layer, but the present disclosure is not limited thereto. In other embodiments, the display medium 106 may be a liquid crystal display layer, an electrowetting display layer, a liquid powder display layer, etc. The material of the connection layer 112 may be optical clear adhesive (OCA), optical clear resin (OCR) and/or other suitable materials.

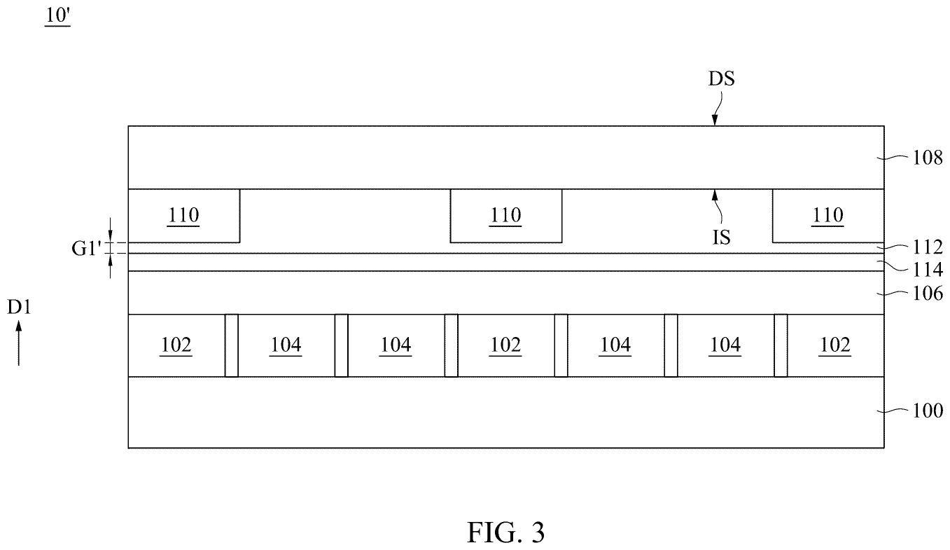

FIG. 3 is a partial schematic cross-sectional view of a display area AA of a display device 10′ according to at least another embodiment of the present disclosure. Referring to FIG. 3, the structures, the materials and the relative positions of most elements in the embodiment of FIG. 3 and the embodiment of FIG. 2 are the same, and the schematic top view of the display device 10′ in FIG. 3 is substantially the same as the schematic top view of the display device 10 in FIG. 2, so the same features are not repeated here. The main difference between the embodiment of FIG. 3 and the embodiment of FIG. 2 is that the display device 10′ further includes an intermediate layer 114 disposed between the display medium 106 and the connection layer 112.

In detail, the intermediate layer 114 may be formed on the display medium 106, for example, in contact with the display medium 106, and the connection layer 112 is disposed between the solar cells 110, the second substrate 108 and the intermediate layer 114 for connecting to the solar cells 110, the second substrate 108 and the intermediate layer 114. That is, a gap G1′ may exist between the solar cells 110 and the intermediate layer 114, and the connection layer 112 may be located in the gap G1′.

In some embodiments, the intermediate layer 114 may be, for example, a protective layer, an optical layer, a water vapor barrier layer, a planar layer, an adhesion adjustment layer. The material of the intermediate layer 114 may be, for example, a transparent organic insulating layer, an inorganic insulating layer, or a combination thereof. The material of the organic insulating layer may be, for example, polymethyl methacrylate, siloxane, polyimide, epoxy resin. The material of the inorganic insulating layer may be, for example, silicon oxide, silicon nitride, and silicon oxynitride.

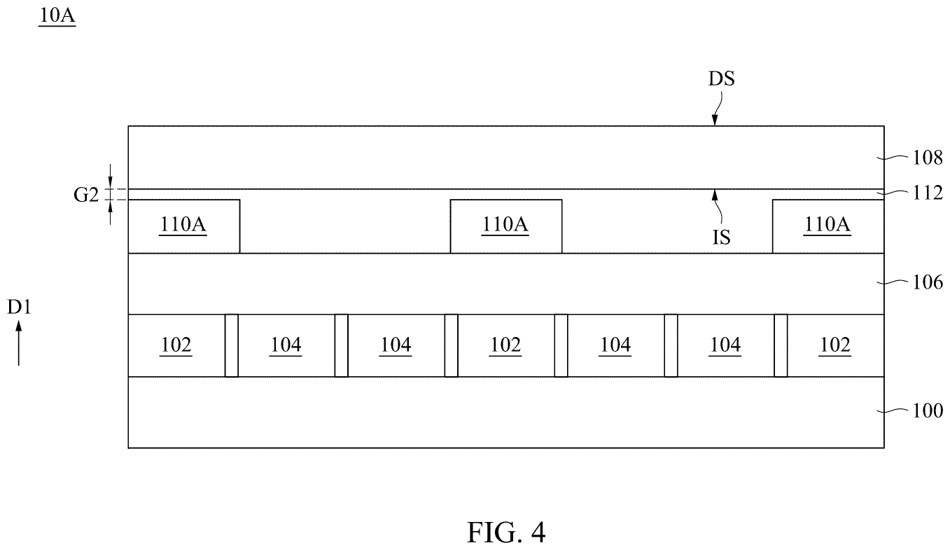

FIG. 4 is a partial schematic cross-sectional view of a display area AA of a display device 10A according to at least another embodiment of the present disclosure. Referring to FIG. 4, the structures, the materials and the relative positions of most elements in the embodiment of FIG. 4 and the embodiment of FIG. 2 are the same, and the schematic top view of the display device 10A in FIG. 4 is substantially the same as the schematic top view of the display device 10 in FIG. 2, so the same features are not repeated here. The main difference between the embodiment of FIG. 4 and the embodiment of FIG. 2 is that the solar cells 110A of the display device 10A is located between the display medium 106 and the connection layer 112.

In detail, the solar cells 110A may be formed on the display medium 106, for example, in contact with the display medium 106, and the connection layer 112 is disposed between the solar cells 110A, the display medium 106 and the second substrate 108 for connecting to the solar cells 110A, the display medium 106 and the second substrate 108. That is, a gap G2 may exist between the solar cells 110A and the second substrate 108, and the connection layer 112 may be located in the gap G2.

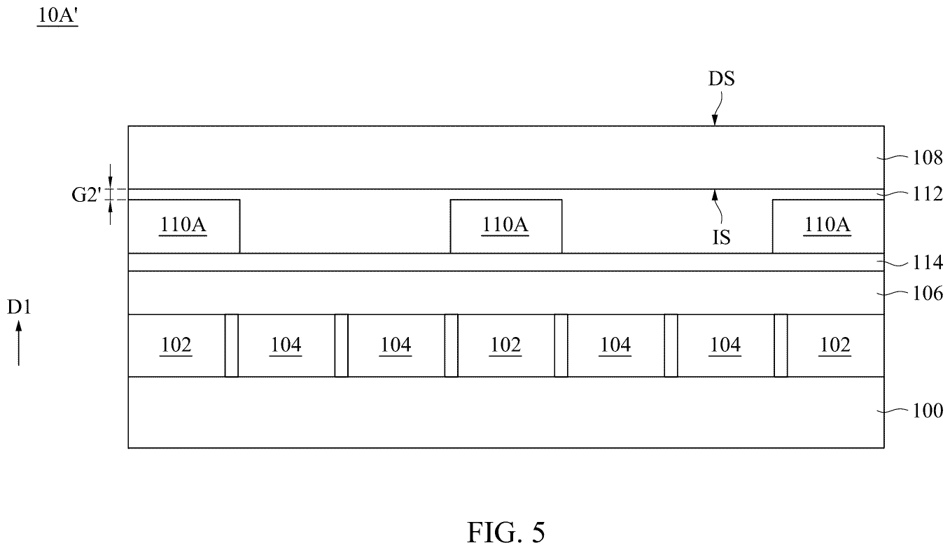

FIG. 5 is a partial schematic cross-sectional view of a display area AA of a display device 10A′ according to at least another embodiment of the present disclosure. Referring to FIG. 5, the structures, the materials and the relative positions of most elements in the embodiment of FIG. 5 and the embodiment of FIG. 4 are the same, and the schematic top view of the display device 10A′ in FIG. 5 is substantially the same as the schematic top view of the display device 10 in FIG. 2, so the same features are not repeated here. The main difference between the embodiment of FIG. 5 and the embodiment of FIG. 4 is that the display device 10A′ further includes an intermediate layer 114 disposed between the connection layer 112, the solar cells 110A and the display medium 106.

In detail, the intermediate layer 114 may be formed on the display medium 106, for example, in contact with the display medium 106, and the connection layer 112 is disposed between the solar cells 110, the intermediate layer 114 and the second substrate 108 for connecting to the solar cells 110, the intermediate layer 114 and the second substrate 108. That is, a gap G2′ may exist between the solar cells 110A and the second substrate 108, and the connection layer 112 may be located in the gap G2′.

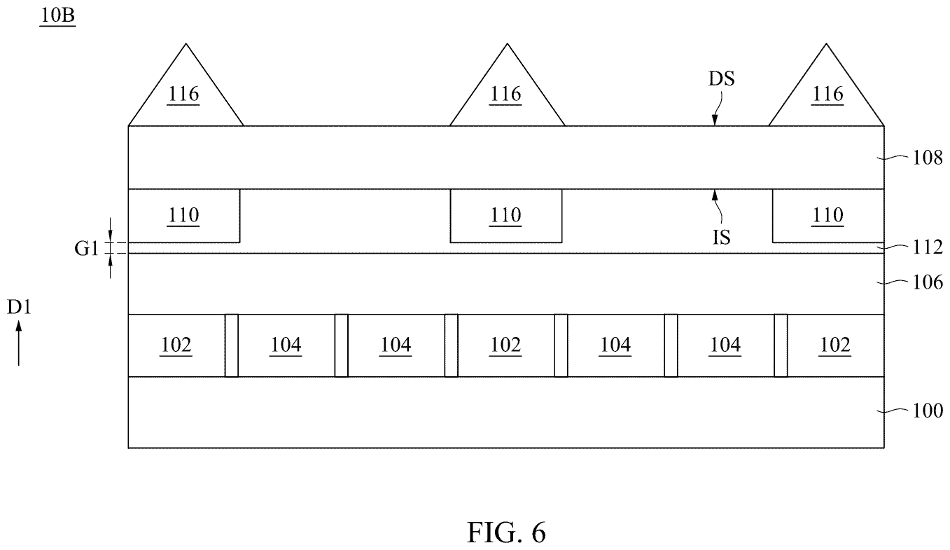

FIG. 6 is a partial schematic cross-sectional view of a display area AA of a display device 10B according to at least another embodiment of the present disclosure. Referring to FIG. 6, the structures, the materials and the relative positions of most elements in the embodiment of FIG. 6 and the embodiment of FIG. 2 are the same, and the schematic top view of the display device 10B in FIG. 6 is substantially the same as the schematic top view of the display device 10 in FIG. 2, so the same features are not repeated here. The main difference between the embodiment of FIG. 6 and the embodiment of FIG. 2 is that the display device 10B further includes multiple first prisms 116 disposed on the second substrate 108.

In detail, the first prisms 116 are disposed on the display surface DS of the second substrate 108. In the normal line of the first substrate 100, the first prisms 116 overlap the solar cells 110, respectively. That is, the first prisms 116 overlap the first pixel electrodes 102, respectively. In some embodiments, the first prisms 116 have a light-collecting function, and can collect external light incident on the display device 10B to the solar cells 110 overlapping therewith, thereby improving the efficiency of the solar cells 110. The first prisms 116 may be, for example, triangular prisms.

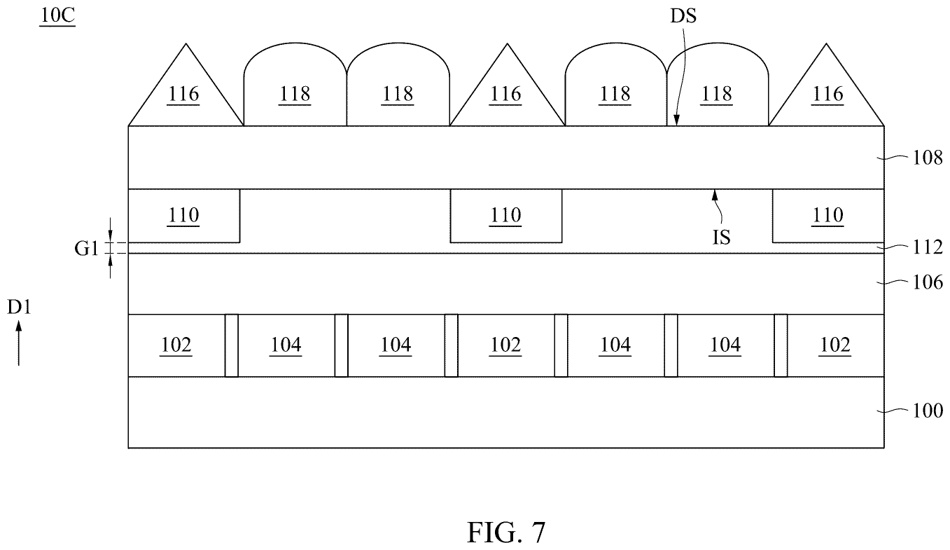

FIG. 7 is a partial schematic cross-sectional view of a display area AA of a display device 10C according to at least another embodiment of the present disclosure. Referring to FIG. 7, the structures, the materials and the relative positions of most elements in the embodiment of FIG. 7 and the embodiment of FIG. 6 are the same, and the schematic top view of the display device 10C in FIG. 7 is substantially the same as the schematic top view of the display device 10 in FIG. 2, so the same features are not repeated here. The main difference between the embodiment of FIG. 7 and the embodiment of FIG. 6 is that the display device 10C further includes multiple second prisms 118 disposed on the second substrate 108.

In detail, the second prisms 118 are disposed on the display surface DS of the second substrate 108, and in the normal line of the first substrate 100, the second prisms 118 overlap the second pixel electrodes 104, respectively. In some embodiments, the second prisms 118 have a brightness adjustment function, and can concentrate the light emitted by the display device 10C to adjust the brightness of the display device 10C. The second prisms 118 may be, for example, cylindrical prisms or triangular prisms. However, although the display device 10C of this embodiment includes the first prisms 116 and the second prisms 118, in other embodiments, the display device 10C may not include the first prisms 116.

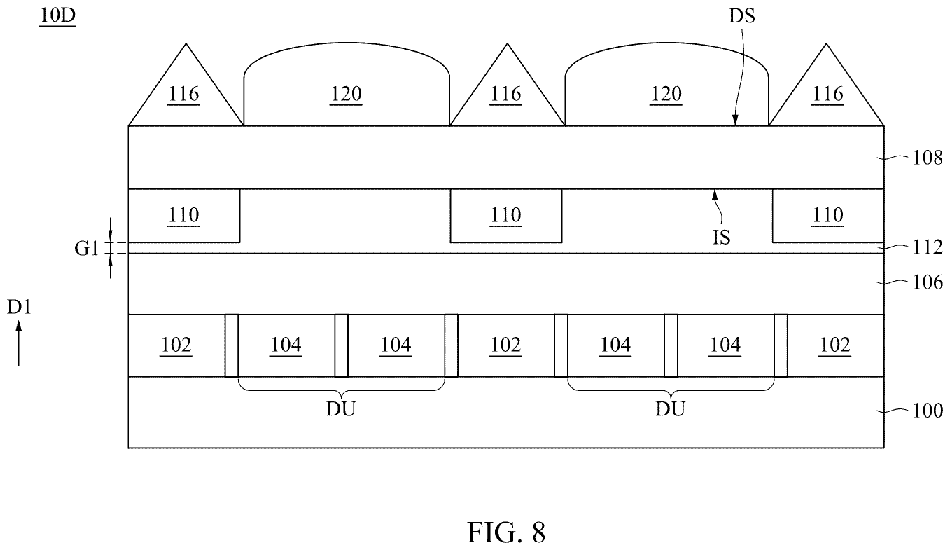

FIG. 8 is a partial schematic cross-sectional view of a display area AA of a display device 10D according to at least another embodiment of the present disclosure. Referring to FIG. 8, the structures, the materials and the relative positions of most elements in the embodiment of FIG. 8 and the embodiment of FIG. 6 are the same, and the schematic top view of the display device 10D in FIG. 8 is substantially the same as the schematic top view of the display device 10 in FIG. 2, so the same features are not repeated here. The main difference between the embodiment of FIG. 8 and the embodiment of FIG. 6 is that the display device 10D further includes multiple lenticular lenses 120 disposed on the second substrate 108.

In detail, the lenticular lenses 120 are disposed on the display surface DS of the second substrate 108, and the display device 10D includes multiple display units DU, each of the display units DU includes two adjacent ones of the second pixel electrodes 104. In the normal line of the first substrate 100, the lenticular lenses 120 overlap the display units DU, respectively. In some embodiments, the lenticular lenses 120 have a light splitting function, and can split the images displayed by the corresponding display medium 106 which is driven by two adjacent ones of the second pixel electrodes 104 of the display unit DU to be emitted in different directions.

For example, in each of the display units DU, two adjacent second pixel electrodes 104 drive the display medium 106 corresponding to the aforementioned two adjacent second pixel electrodes 104 to display a first image and a second image, respectively, and the first image and the second image are different, e.g., the first image and the second image may be different images respectively watched by viewers at different viewing angles, or the first image and the second image may be different images respectively watched by the left eye and the right eye of the same viewer to achieve a three-dimensional display effect using parallax. However, although the display device 10D of this embodiment includes the first prisms 116 and the lenticular lenses 120, in other embodiments, the display device 10D may not include the first prisms 116.

In addition, it should be understood that while the display devices 10B, 10C, 10D of FIG. 6 to FIG. 8 are illustrated by the example of the display device 10 of FIG. 2 further including the first prisms 116, the second prisms 118, and the lenticular lenses 120. However, in other embodiments, the display devices 10′, 10A, 10A′ of FIG. 3 to FIG. 5 may also further include the first prisms 116, the second prisms 118, and the lenticular lenses 120.

In summary, in at least one embodiment of the display device of the present disclosure, since the solar cells are disposed in the display area in correspondence with the first pixel electrodes, and the second pixel electrodes are used for displaying image, sufficient power can be generated to supply the display device without reducing the area of the display area and the appearance of the display device can be improved.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. A display device, comprising:
a first substrate;
a plurality of first pixel electrodes, disposed on the first substrate;
a plurality of second pixel electrodes, disposed on the first substrate;
a display medium, disposed on the first pixel electrodes and the second pixel electrodes;
a second substrate, disposed opposite to the first substrate; and
a plurality of solar cells, disposed between the first substrate and the second substrate, and overlapping the first pixel electrodes in a normal line of the first substrate, respectively.

2. The display device of claim 1, wherein a total area of the first pixel electrodes is smaller than a total area of the second pixel electrodes.

3. The display device of claim 2, wherein a ratio of a total area of the solar cells to a sum of the total area of the first pixel electrodes and the total area of the second pixel electrodes is 0.05 to 0.5.

4. The display device of claim 1, further comprising:
a connection layer, disposed between the display medium and the second substrate, and connecting to the display medium and the second substrate, wherein the solar cells are located between the second substrate and the connection layer.

5. The display device of claim 4, further comprising:
an intermediate layer, disposed between the display medium and the connection layer.

6. The display device of claim 1, further comprising:
a connection layer, disposed between the display medium and the second substrate, and connecting to the display medium and the second substrate, wherein the solar cells are located between the display medium and the connection layer.

7. The display device of claim 6, further comprising:
an intermediate layer, disposed between the display medium and the solar cells.

8. The display device of claim 1, further comprising:
a plurality of first prisms, disposed on the second substrate, wherein the first prisms overlap the solar cells in the normal line of the first substrate, respectively.

9. The display device of claim 8, wherein the first prisms are used to collect external light incident on the display device to the solar cells.

10. The display device of claim 1, further comprising:
a plurality of second prisms, disposed on the second substrate, wherein the second prisms overlap the second electrodes in the normal line of the first substrate, respectively.

11. The display device of claim 10, wherein the second prisms are used to concentrate light emitted by the display device.

12. The display device of claim 1, further comprising:
a plurality of lenticular lenses, disposed on the second substrate, wherein the display device comprises a plurality of display units, and each of the display units comprises two adjacent ones of the second pixel electrodes, wherein the lenticular lenses overlap the display units in the normal line of the first substrate, respectively.

13. The display device of claim 12, wherein in each of the display units, the two adjacent ones of the second pixel electrodes drive the display medium corresponding to the two adjacent ones of the second pixel electrodes to display a first image and a second image, respectively, and the first image is different from the second image.

14. The display device of claim 1, wherein each of the first pixel electrodes drives the display medium corresponding to each of the first pixel electrodes to display an image, wherein a color of the image is not black.

15. The display device of claim 14, wherein the image reflects light to the solar cells.

16. A display device, comprising:
a first substrate;
a plurality of first pixel electrodes, disposed on the first substrate;
a plurality of second pixel electrodes, disposed on the first substrate;
a display medium, disposed on the first pixel electrodes and the second pixel electrodes;
a second substrate, disposed opposite to the first substrate, wherein the second substrate has a display surface facing away from the first substrate and an inner surface facing the first substrate; and
a plurality of solar cells, disposed between the first substrate and the inner surface of the second substrate, and overlapping the first pixel electrodes in a normal line of the first substrate, respectively.

17. The display device of claim 16, wherein the solar cells are in contact with the inner surface of the second substrate.

18. The display device of claim 16, further comprises:
a connection layer, wherein a gap exists between the inner surface of the second substrate and the solar cells, and the connection layer is located in the gap.
